(19) United States
(12) Patent Application Publication
(10) Pub. No.: US 2006/0288262 A1
(43) Pub. Date: Dec. 21, 2006

(54) Optical disc reproducing apparatus

(75) Inventor: Shigeru Toji, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/454,978

(22) Filed: Jun. 19, 2006

(30) Foreign Application Priority Data
Jun. 20, 2005 (JP) 2005-179439

(51) Int. Cl. G06K 5/04

(52) U.S. Cl. 714/699

(57) ABSTRACT

When an error arises during the reproduction of a file from an optical disc, the error is detected by error detecting means, and the cause of the error is discriminated by error discriminating means. If the cause discriminated by the error discriminating means suggests that the error has arisen during decoding, the error is one of a read error, an input stream error, a specified data type error, a chroma format error, a monochrome image error, a stream error, or a time-out error. Thus, whichever of these errors is closest to the cause of the error is indicated on a display device by error indicating means. This helps reduce the possibility of unreproducible files being recorded to an optical disc next time an optical disc having files recorded thereon is created.

This application is based on Japanese Patent Application No. 2005-179439 filed on Jun. 20, 2005, the contents of which are hereby incorporated by reference.

### BACKGROUND OF THE INVENTION

1. Field of the Invention

The present invention relates to an optical disc reproducing apparatus that reproduces information from an optical disc having recorded thereon at least one of the following types of files: music files in MP3 format, music files in WMA format, and still image files in JPEG format. More particularly, the present invention relates to error indication in a case where an attempt is made to reproduce an unreproducible file.

2. Description of Related Art

Recently, optical disc reproducing apparatuses have been becoming increasingly popular that are capable of reproducing information from an optical disc having recorded thereon at least one of the following types of files: music files in MP3 format, music files in WMA format, and still image files in JPEG format. In such conventional optical disc reproducing apparatuses, during the reproduction of files from an optical disc, if a file is found to be unreadable, an error is indicated, for example, to make the user aware that the file cannot be reproduced.

Typical among such errors are the following 13 errors: a read error indicating that data cannot be read from an optical disc; a format error indicating an unacceptable format; a sampling frequency error indicating an unsupported sampling frequency; a bit rate error indicating an unsupported bit rate; an unexpected error; a communication error; an input stream error indicating that an input stream does not conform to decodable specifications; a specified data type error indicating that a specified data type does not exist in a stream; a chroma format error indicating an unsupported chroma format; a JPEG image size error indicating that a JPEG image is larger than the largest acceptable size; a monochrome image error indicating a monochrome image; a stream error; and a time-out error.

Inconveniently, however, despite the 13 different errors mentioned above, in conventional optical disc reproducing apparatuses, when an error arises during the reproduction of an optical disc, simply an error is indicated without notifying the user of the cause of the error.

Incidentally, JP-A-H8-87577 describes a conventional technique directed to multimedia paper (MMP) for recording music, images, and the like. According to this technique, when an error arises and makes the restoration of original multimedia information impossible, the cause of the error is indicated by error indicating means. Examples of the so indicated errors include: one indicating codes unregistered in the multimedia paper (MMP) standards; one indicating codes nonconforming to the multimedia paper (MMP) standards; and one indicating impossibility to reproduce. Certainly this technique allows the indication of the cause of an error, but it is directed to an information reproducing apparatus that reproduces information from multimedia paper as a recording medium. That is, this technique is not directed to an optical disc reproducing apparatus that reproduces an optical disc having recorded thereon at least one type of files among music files in MP3 format, music files in WMA format, and still image files in JPEG format.

### SUMMARY OF THE INVENTION

The present invention has been made to solve the inconvenience mentioned above, and an object of the present invention is to provide an optical disc reproducing apparatus capable of, when an attempt is made to reproduce an unreproducible file from an optical disc, indicating the cause for which it cannot be reproduced.

To achieve the above object, according to the present invention, an optical disc reproducing apparatus is provided with a system controller that, when an error arises during reproduction of information from an optical disc having recorded thereon a file in a predetermined format, discriminates a cause of the error and indicates an error closest thereto on a display device.

In this configuration, when an error arises during the reproduction of information from an optical disc, the cause of the error is discriminated, and then an error closest to the cause of the error is indicated on the display device.

With this configuration, when an attempt is made to reproduce an unreproducible file from the optical disc, the cause for which it cannot be reproduced is indicated. This helps reduce the possibility of unreproducible files being recorded to an optical disc next time an optical disc having files in predetermined formats recorded thereon is created on a personal computer or the like. This saves the user from wasting optical discs.

Furthermore, in the optical disc reproducing apparatus configured as described above, the file in the predetermined format is any of at least the following files: a music file in MP3 format, a music file in WMA format, and a still image file in JPEG format. Thus, it is possible to reproduce music files in MP3 format, music files in WMA format, and still image files in JPEG format.

Moreover, in the optical disc reproducing apparatus configured as described above, possible errors that may arise during the reproduction of information from the optical disc are: a read error indicating that data cannot be read from an optical disc; a format error indicating an unacceptable format; a sampling frequency error indicating an unsupported sampling frequency; a bit rate error indicating an unsupported bit rate; an unexpected error; a communication error; an input stream error indicating that an input stream does not conform to decodable specifications; a specified data type error indicating that a specified data type does not exist in a stream; a chroma format error indicating an unsupported chroma format; a JPEG image size error indicating that a JPEG image larger than a largest acceptable size; a monochrome image error indicating a monochrome image; a stream error; and a time-out error. Thus, it is possible to discriminate these errors.

In the optical disc reproducing apparatus configured as described above, the system controller is provided with: error detecting means that individually detects the read error, the format error, the sampling frequency error, the bit rate error, the unexpected error, the communication error, the input stream error, the specified data type error, the chroma format error, the JPEG image size error, the monochrome image error, the stream error, and the time-out error; error discriminating means that discriminates an error detected by the error detecting means according to the cause of the error to recognize whether the error has arisen during header analysis, decoding, or other processing; and error indicating means that, when an error arises during the reproduction of the optical disc, indicates, among the possible errors, an error closest to the cause of the error.

With this configuration, it is possible to individually detect a read error, a format error, a sampling frequency error, a bit rate error, an unexpected error, a communication error, an input stream error, a specified data type error, a chroma format error, a JPEG image size error, a monochrome image error, a stream error, and a time-out error. Furthermore, it is possible to discriminate an error according to its cause to recognize whether the error has arisen during header analysis, decoding, or other processing. Moreover, when an error arises during reproduction, it is possible to indicate, on the display device, whichever of the different errors mentioned above is closest to the cause of the error. This helps reduce the possibility of unreproducible files being recorded to an optical disc next time that, on a personal computer or the like, an optical disc is created that has recorded thereon at least one type of files among music files in MP3 format, music files in WMA format, and still image files in JPEG format. This saves the user from wasting optical discs.

As described above, according to the present invention, when an attempt is made to reproduce an unreproducible file from an optical disc, the cause for which it cannot be reproduced is indicated. This helps reduce the possibility of unreproducible files being recorded to an optical disc next time an optical disc having files in predetermined formats recorded thereon is created on a personal computer or the like. This saves the user from wasting optical discs.

### BRIEF DESCRIPTION OF THE DRAWINGS

FIG. 1 is a block diagram showing the configuration of an optical disc reproducing apparatus embodying the present invention; and

FIG. 2 is a flow chart illustrating how errors are discriminated in the embodiment.

### DETAILED DESCRIPTION OF PREFERRED EMBODIMENTS

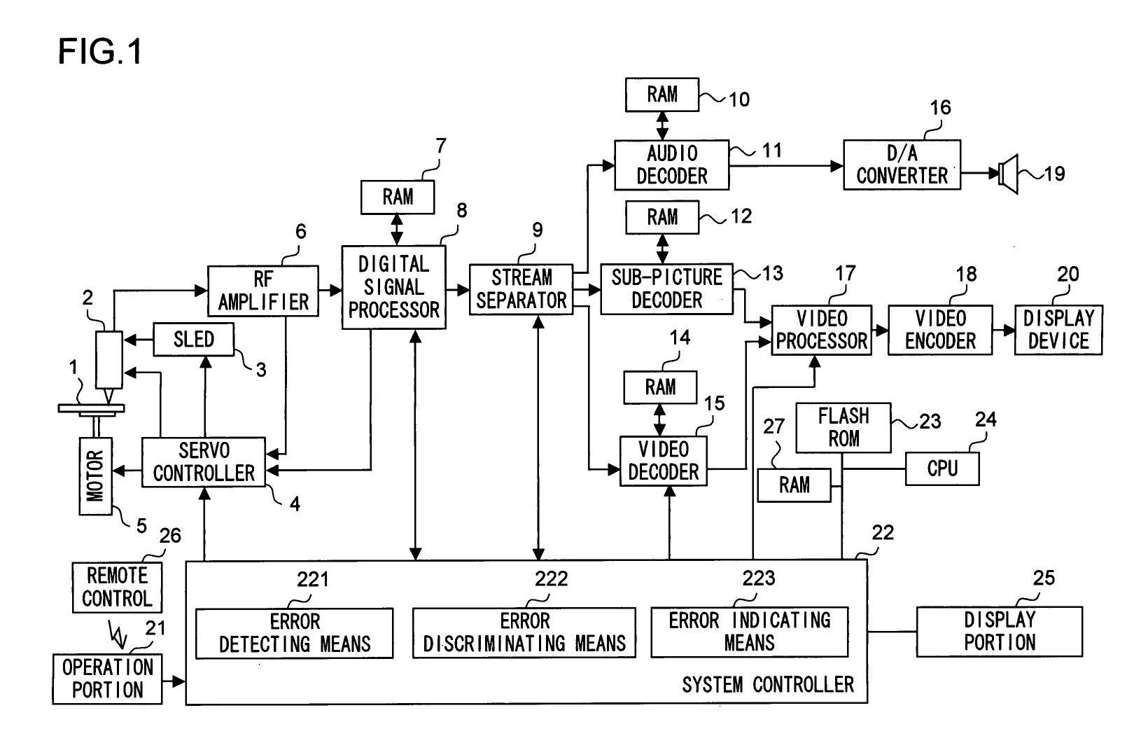

Hereinafter, embodiments of the present invention will be described with reference to the accompanying drawings. FIG. 1 is a block diagram showing the configuration of an optical disc reproducing apparatus embodying the present invention.

An optical disc reproducing apparatus according to the present invention is provided with: a spindle motor 5 that turns an optical disc 1; an optical pickup 2 that emits laser light for reproducing information recorded on the optical disc 1 and that receives light reflected from the optical disc 1; a sled 3 that moves the optical pickup 2 in a radial direction of the optical disc 1; a system controller 22 that controls the apparatus as a whole; and a servo controller 4 that drives the spindle motor 5 and the sled 3 according to instructions from the system controller 22 and moves a focal position of the laser light in perpendicular and parallel directions with respect to a recording surface of the optical disc 1 by moving an objective lens (not shown) incorporated in the optical pickup 2.

The optical disc reproducing apparatus is further provided with: an RF amplifier 6 that, when the optical disc 1 is reproduced, amplifies an RF signal fed, as a readout signal, from the optical pickup 2; a digital signal processor 8 that converts the RF signal outputted from the RF amplifier 6 into digital data, then performs signal demodulation and error correction according to the data format of the optical disc 1, and then stores the resulting data in a RAM 7; and a stream separator 9 that, according to instructions from the system controller 22, separates audio data, sub-picture data, and video data (moving image data in MPEG format or still image data in JPEG format) from the data stream outputted from the digital signal processor 8.

The optical disc reproducing apparatus is further provided with: an audio decoder 11 to which is inputted the audio data outputted from the stream separator 9 and that performs predetermined decoding; a RAM 10 that temporarily stores data for the audio decoder 11 to perform decoding; a sub-picture decoder 13 to which is inputted the sub-picture data outputted from the stream separator 9 and that performs predetermined decoding; a RAM 12 that temporarily stores data for the sub-picture decoder 13 to perform decoding; a video decoder 15 to which is inputted the video data outputted from the stream separator 9 and that performs predetermined decoding; and a RAM 14 that temporarily stores data for the video decoder 15 to perform decoding.

The optical disc reproducing apparatus is further provided with: a video processor 17 that, according to instructions from the system controller 22, synthesizes the data outputted from the video decoder 15 and the data outputted from the sub-picture decoder 13; a video encoder 18 that converts the synthesized data outputted from the video processor 17 into a display video signal so as to permit a display device 20 to display an image; and a D/A converter 16 that converts the data outputted from the audio decoder 11 into an analogue audio signal and then feeds it to a speaker 19 or the like.

The optical disc reproducing apparatus is further provided with: a remote control 26 having a play key (not shown) for instructing the system controller 22 to start reproduction, a stop key (not shown) for instructing it to stop reproduction, a fast-forward key (not shown), a fast-backward key (not shown), and other operation keys (not shown); and an operation portion 21 that has fewer operation keys than the remote control 26 does and that, by using light receiving means (not shown) that receives an optical signal carrying an operation instruction from the remote control 26, converts the optical signal into an electric signal that carries the operation instruction to the system controller 22.

The optical disc reproducing apparatus is further provided with: a flash ROM 23 that stores programs and data for controlling the individual components of the apparatus and the apparatus as a whole; and a CPU 24 that performs computation according to the programs and data stored in the flash ROM 23, thereby controlling the system controller 22; a RAM 27 that temporarily stores data that is necessary for the CPU 24 to perform computation; and a display portion 25 located on the apparatus body that displays operation status and the like transmitted from the operation portion 21 or the remote control 26.

This embodiment is characterized in that the system controller 22 is additionally provided with error detecting means 221, error discriminating means 222, and error indicating means 223. The error detecting means 221 individually detects a read error indicating that data cannot be read from the optical disc 1, a format error indicating an unacceptable format, a sampling frequency error indicating an unsupported sampling frequency, a bit rate error indicating an unsupported bit rate, an unexpected error, a communication error, an input stream error indicating that an input stream does not conform to decodable specifications, an specified data type error indicating that a specified data type does not exist in a stream, a chroma format error indicating an unsupported chroma format, a JPEG image size error indicating that an JPEG image is larger that the largest acceptable size, a monochrome image error indicating a monochrome image, a stream error, and a time-out error. The error discriminating means 222 discriminates an error detected by the error detecting means 221 according to the cause of the error to recognize whether the error has arisen during header analysis, decoding, or other processing. The error indicating means 223 indicates, when an error arises during reproduction, whichever of the different errors mentioned above is closest to the cause of the error.

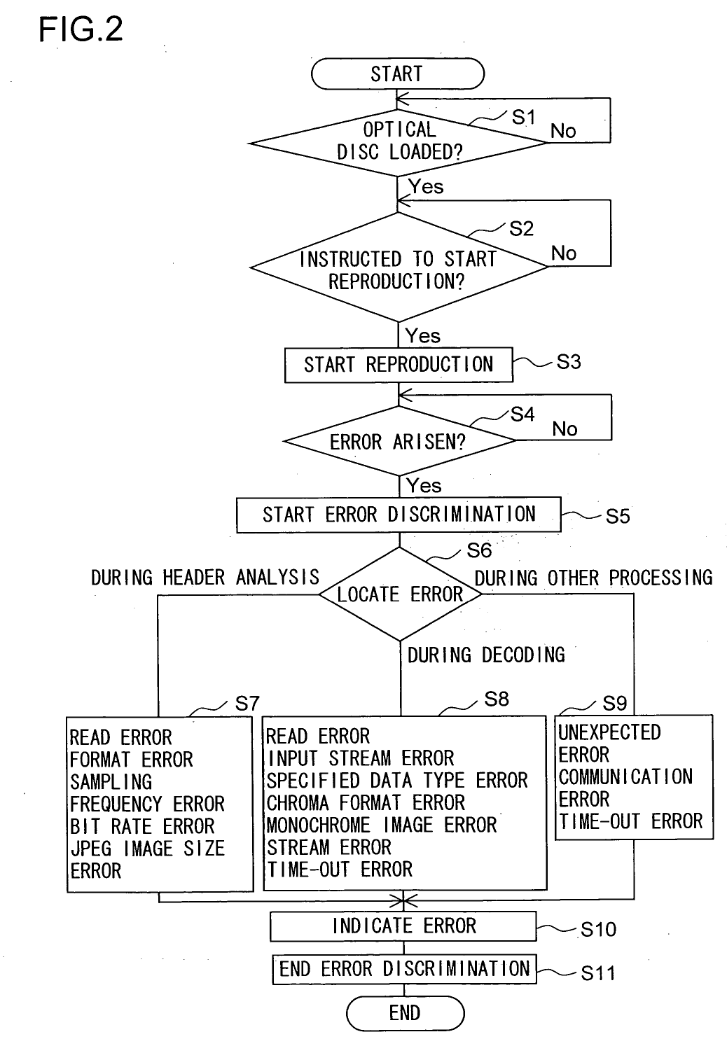

FIG. 2 is a flow chart illustrating how errors are discriminated in the embodiment. Now, with reference to this flow chart and FIG. 1, how error discrimination is achieved will be described.

First, when an optical disc 1 having music files in MP3 format, music files in WMA format, and still image files in JPEG format recorded thereon is loaded into the optical disc reproducing apparatus, the system controller 22 detects the loading of the optical disc 1 (step S1), and then gets ready to play the optical disc 1. Thereafter, when, for example, the play key on the remote control 26 is pressed, in response the system controller 22 makes the spindle motor 5 rotate via the servo controller 4 to make the optical disc 1 rotate, and also drive the optical pickup 2, to start the reproduction of the optical disc 1 (step S3).

If, during the reproduction of the optical disc 1 (step S3), an error arises and is detected by the error detecting means 221 of the system controller 22 (step S4), the system controller 22 starts the discrimination of the error (step S5) to locate where it has arisen (step S6). More specifically, if an error arises during the reproduction of the optical disc 1, the error is detected by the error detecting means 221, and then discriminated according to the cause thereof by the error discriminating means 222.

If the error discriminated by the error discriminating means 222 is, for example, one having arisen, for example, during header analysis, the error consists of one or more of the following errors: a read error indicating that data cannot be read from the optical disc 1; a format error indicating an unacceptable format; a sampling frequency error indicating an unsupported sampling frequency; a bit rate error indicating an unsupported bit rate; and a JPEG image size error indicating that a JPEG image is larger than the largest acceptable size (step S7).

The error indicating means 223 of the system controller 22 indicates whichever of these errors is closest to the cause of the error on the display device 20 (step S10). For example, if data cannot be read from a file during the analysis of its header, a message “read error” is indicated on the display device 20. For another example, if a music file that should be in MP3 format is found out to have been recorded in another format, a message “format error” is indicated on the display device 20.

The system controller 22, when reproducing a music file in MP3 format or in WMA format, receives from the audio decoder 11 information about the sampling frequency and the bit rate of the music file, and based on the information judges whether or not the music file is reproducible. If the music file cannot be reproduced because the sampling frequency thereof is unsupported, the system controller 22 indicates a message “sampling frequency error” on the display device 20, and if the music file cannot be reproduced because the bit rate thereof is unsupported, the system controller 22 indicates a message “bit rate error” on the display device 20. If the video decoder 15 cannot accept the size of an image, that is, the size of the image is larger than the size of the largest reproducible still image (JPEG image), the system controller 22 indicates a message “JPEG image size error” on the display device 20.

If the error discriminated by the error discriminating means 222 is, for example, one having arisen during decoding by the audio decoder 11, the sub-picture decoder 13, or the video decoder 15, the error consists of one or more of the following errors: a read error indicating that data cannot be read from the optical disc 1; an input stream error indicating that an input stream does not conform to decodable specifications; an specified data type error indicating that a specified data type does not exist in a stream; a chroma format error indicating an unsupported chroma format; a monochrome image error indicating a monochrome image; a stream error; and a time-out error (step S8).

The error indicating means 223 of the system controller 22 indicates whichever of these errors is closest to the cause of the error on the display device 20 (step S10). For example, if data cannot be read from a file during decoding, a message “read error” is indicated on the display device 20. For another example, if an input stream to the audio decoder 11, the sub-picture decoder 13, or the video decoder 15 does not conform to decodable specifications, the error indicating means 223 indicates a message “input stream error” on the display device 20.

If, for example, data is in one of the prescribed JPEG formats but a specified data type does not exist in its stream because part of the data is missing or is not recorded, the error indicating means 223 indicates a message “specified data type error” on the display device 20. For another example, if the error is due to a variant of JPEG format incompatible with the video decoder 15, the error indicating means 223 indicates a message “chroma format error” on the display device 20.

If the error is due to an image that the video decoder 15 cannot accept, the error indicating means 223 indicates a message “monochrome image error” on the display device 20. If the error is related to the stream (for example, MPEG), the error indicating means 223 indicates a message “stream error” on the display device 20. If the error results from failure to perform reproduction within a predetermined period after an instruction was given to start it, the error indicating means 223 indicates a message “time-out error” on the display device 20.

If the error discriminated by the error discriminating means 222 is other than those already mentioned, the error consists of one or more of an unexpected error, a communication error, and a time-out error (step S9). In this case, the error indicating means 223 of the system controller 22 indicates whichever of these errors is closest to the cause of the error on the display device 20 (step S10).

For example, if the error is an unexpected error arisen from a cause in hardware, the error indicating means 223 indicates a message “unexpected error” on the display device 20. If the error is a communication error arisen from a cause in hardware, the error indicating means 223 indicates a message “time-out error” on the display device 20. If the error results from failure to perform reproduction within a predetermined period after an instruction was given to start it, the error indicating means 223 indicates a message “time-out error” on the display device 20.

Through the procedure described above, an error is discriminated (step S7, step S8, and step S9), an error indication is indicated (step S10), and an error discrimination is ended (step S11).

As discussed above, according to this embodiment, when an attempt is made to reproduce an unreproducible file from an optical disc, the cause for which it cannot be reproduced is indicated. This helps reduce the possibility of unreproducible files being recorded to an optical disc next time that, on a personal computer or the like, an optical disc is created that has recorded thereon at least one type of files among music files in MP3 format, music files in WMA format, and still image files in JPEG format. This saves the user from wasting optical discs.

The embodiment described above deals with error indication during the reproduction of an optical disc having recorded thereon at least one type of files among music files in MP3 format, music files in WMA format, and still image files in JPEG format, but it should be understood that error indication during the reproduction of an optical disc having recorded thereon files in file formats other than those specifically mentioned above can be achieved through a procedure similar to that described above.

What is claimed is:

1. An optical disc reproducing apparatus comprising:
a system controller that, when an error arises during reproduction of information from an optical disc having recorded thereon a file in a predetermined format, discriminates a cause of the error, and indicates an error closest thereto on a display device.

2. The optical disc reproducing apparatus of claim 1,
wherein the file in the predetermined format is any of at least the following files: a music file in MP3 format; a music file in WMA format; and a still image file in JPEG format.

3. The optical disc reproducing apparatus of claim 1,
wherein possible errors that may arise during the reproduction of information from the optical disc are:
a read error indicating that data cannot be read from an optical disc;
a format error indicating an unacceptable format
a sampling frequency error indicating an unsupported sampling frequency;
a bit rate error indicating an unsupported bit rate;
an unexpected error;
a communication error;
an input stream error indicating that an input stream does not conform to decodable specifications;
a specified data type error indicating that a specified data type does not exist in a stream;
a chroma format error indicating an unsupported chroma format;
a JPEG image size error indicating that a JPEG image is larger than a largest acceptable size;
a monochrome image error indicating a monochrome image;
a stream error; and
a time-out error.

4. The optical disc reproducing apparatus of claim 1,
wherein the system controller comprises:
error detecting means that individually detects:
the read error;
the format error;
the sampling frequency error;
the bit rate error;
the unexpected error;
the communication error;
the input stream error;
the specified data type error;
the chroma format error;
the JPEG image size error;
the monochrome image error;
the stream error; and
the time-out error;
error discriminating means that discriminates an error detected by the error detecting means according to a cause of the error to recognize whether the error has arisen during header analysis, decoding, or other processing; and
error indicating means that, when an error arises during the reproduction of the optical disc, indicates, among the possible errors, an error closest to the cause of the error.

5. The optical disc reproducing apparatus of claim 2,
wherein possible errors that may arise during the reproduction of information from the optical disc are:
a read error indicating that data cannot be read from an optical disc;
a format error indicating an unacceptable format
a sampling frequency error indicating an unsupported sampling frequency;
a bit rate error indicating an unsupported bit rate;
an unexpected error;
a communication error;
an input stream error indicating that an input stream does not conform to decodable specifications;
a specified data type error indicating that a specified data type does not exist in a stream;
a chroma format error indicating an unsupported chroma format;
a JPEG image size error indicating that a JPEG image is larger than a largest acceptable size;
a monochrome image error indicating a monochrome image;
a stream error; and
a time-out error.

6. The optical disc reproducing apparatus of claim 2,
wherein the system controller comprises:
error detecting means that individually detects:
the read error;
the format error;
the sampling frequency error;
the bit rate error;
the unexpected error;
the communication error;
the input stream error;
the specified data type error;
the chroma format error;
the JPEG image size error;
the monochrome image error;
the stream error; and
the time-out error;
error discriminating means that discriminates an error detected by the error detecting means according to a cause of the error to recognize whether the error has arisen during header analysis, decoding, or other processing; and
error indicating means that, when an error arises during the reproduction of the optical disc, indicates, among the possible errors, an error closest to the cause of the error.

7. The optical disc reproducing apparatus of claim 3,
wherein the system controller comprises:
error detecting means that individually detects:
the read error;
the format error;
the sampling frequency error;
the bit rate error;
the unexpected error;
the communication error;
the input stream error;
the specified data type error;
the chroma format error;
the JPEG image size error;
the monochrome image error;
the stream error; and
the time-out error;
error discriminating means that discriminates an error detected by the error detecting means according to a cause of the error to recognize whether the error has arisen during header analysis, decoding, or other processing; and
error indicating means that, when an error arises during the reproduction of the optical disc, indicates, among the possible errors, an error closest to the cause of the error.

8. The optical disc reproducing apparatus of claim 5,
wherein the system controller comprises:
error detecting means that individually detects:
the read error;
the format error;
the sampling frequency error;
the bit rate error;
the unexpected error;
the communication error;
the input stream error;
the specified data type error;
the chroma format error;
the JPEG image size error;
the monochrome image error;
the stream error; and
the time-out error;
error discriminating means that discriminates an error detected by the error detecting means according to a cause of the error to recognize whether the error has arisen during header analysis, decoding, or other processing; and
error indicating means that, when an error arises during the reproduction of the optical disc, indicates, among the possible errors, an error closest to the cause of the error.
